(19) United States
(12) Patent Application Publication
(10) Pub. No.: US 2021/0026782 A1
(43) Pub. Date: Jan. 28, 2021

(54) DATA STORAGE APPARATUS, OPERATING METHOD THEREOF, AND CONTROLLER THEREFOR

(71) Applicant: SK hynix Inc., Gyeonggi-do (KR)

(72) Inventors: Hye Mi KANG, Gyeonggi-go (KR); Eu Joon BYUN, Gyeonggi-go (KR)

(21) Appl. No.: 16/794,917

(22) Filed: Feb. 19, 2020

(30) Foreign Application Priority Data
Jul. 24, 2019 (KR) 10-2019-0089374

(51) Int. Cl. G06F 12/109

(52) U.S. Cl. CPC G06F 12/109; G06F 2212/657

(57) ABSTRACT

A data storage apparatus may include a storage and a controller configured to control the storage in response to a request of a host, wherein the controller comprises a map data management component configured to: generate one or more map segments, each of which includes a plurality of pieces of map data, which represent mapping information between logical addresses of the host and physical addresses of the storage; store the map segments in the storage; group the map data in each of the map segments into groups of one or more sub-segments; and load the map data of each of the map segments in units of the sub-segments.

### CROSS-REFERENCE TO RELATED APPLICATION

The present application claims priority under 35 U.S.C. § 119(a) to Korean application number 10-2019-0089374, filed on Jul. 24, 2019, in the Korean Intellectual Property Office, which is incorporated herein by reference in its entirety.

### BACKGROUND

### 1. Technical Field

Various embodiments generally relate to a semiconductor integrated apparatus, and more particularly, to a data storage apparatus, an operating method thereof, and a controller therefor,

### 2. Related Art

A storage device is electrically connected to a host and performs a data input/output operation at a request of the host. The storage device may use various storage media to store data, and for example, may employ a nonvolatile memory apparatus such as a flash memory apparatus as a storage medium.

In flash memory apparatus, overwriting or in-place update is not possible and a read/write unit and an erase unit are different. Accordingly, it is necessary to map a logical address provided with a read/write request of the host to a physical address and to process the request of the host.

Mapping information between the logical address and the physical address is stored in a nonvolatile memory apparatus, and may be loaded for use to a buffer memory, if necessary.

### SUMMARY

In an embodiment, a data storage apparatus may include: a storage; and a controller configured to control the storage in response to a request of a host, wherein the controller comprises a map data management component configured to: generate one or more map segments, each of which includes a plurality of pieces of map data, which represent mapping information between logical addresses of the host and physical addresses of the storage; store the map segments in the storage; group the map data in each of the map segments into groups of one or more sub-segments; and load the map data of each of the map segments in units of the sub-segments.

In an embodiment, an operating method of a data storage apparatus including a storage and a controller that controls the storage in response to a request of a host may include: generating, by the controller, one or more map segments, each of which includes a plurality of pieces of map data, which are mapping information between logical addresses of the host and physical addresses of the storage, and stores the map segments in the storage; grouping, by the controller, the map data in each of the one or more map segments into groups of one or more sub-segments; and loading the map data of each of the map segments in units of the one or more sub-segments.

In an embodiment, a controller for a data storage apparatus, which controls a storage in response to a request of a host, may include:

a map table management component configured to generate one or more map segments, each of which includes a plurality of pieces of map data, which represent mapping information between logical addresses of the host and physical addresses of the storage; and store the map segments in the storage; and a sub-segment management component configured to: group the map data in each of the map segments into groups of one or more sub-segments; and load the map data of each of the one or more map segments in units of the sub-segments.

In an embodiment, a memory system may include: a memory device including plural storage areas and configured to store a map table having information of a map segment and corresponding meta data; and a controller configured to: cache therein the information of map segment by units of sub-segments; control the memory device to perform an operation based on the cached information; and update the map segment by units of sub-segments as a result of the operation, wherein the map segment includes plural sub-segments, each including one or more pieces of map data respectively corresponding to the storage areas, and wherein the meta data includes validity information of the map segment and the respective sub-segments.

### BRIEF DESCRIPTION OF THE DRAWINGS

FIG. 1 is a diagram illustrating a configuration of a data storage apparatus in accordance with an embodiment.

FIG. 2 is a diagram illustrating a configuration of a controller in accordance with an embodiment.

FIG. 3 is a diagram illustrating a configuration of a map data management component in accordance with an embodiment.

FIG. 4 is a diagram for explaining a map data management technique in accordance with an embodiment.

FIG. 5 is a diagram for explaining a map data management method in accordance with an embodiment.

FIG. 6 is a diagram for explaining an operating method of the data storage apparatus in accordance with an embodiment.

FIG. 7 is a diagram illustrating a configuration of a computing apparatus in accordance with an embodiment.

FIG. 8 is a diagram for explaining an operating method of the computing apparatus in accordance with an embodiment.

FIG. 9 is a diagram illustrating a data storage system in accordance with an embodiment.

FIG. 10 and FIG. 11 are diagrams illustrating a data processing system in accordance with an embodiment.

FIG. 12 is a diagram illustrating a network system including a data storage device in accordance with an embodiment.

FIG. 13 is a block diagram illustrating a nonvolatile memory device included in a data storage device in accordance with an embodiment.

### DETAILED DESCRIPTION

Hereinafter, a data storage apparatus, an operating method thereof, and a controller therefor are described in more detail below with reference to the accompanying drawings. Throughout the specification, reference to “an embodiment” or the like is not necessarily to only one embodiment, and different references to any such phrase are not necessarily to the same embodiment(s). Similarly, the indefinite articles “a” and “an” mean one or more, unless stated otherwise or it is clear from the context that only one is intended.

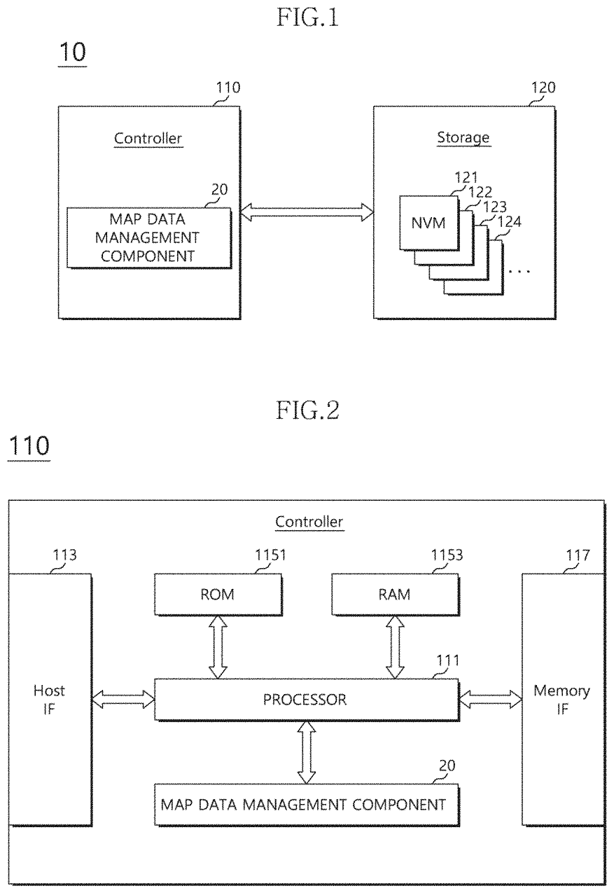

FIG. 1 is a configuration diagram of a data storage apparatus in accordance with an embodiment.

Referring to FIG. 1, a data storage apparatus 10 may include a controller 110 and a storage 120.

The controller 110 may control the storage 120 in response to a request of a host. For example, the controller 110 may control data to be programmed in the storage 120 in response to a program (write) request of the host. Furthermore, the controller 110 may provide the host with the data written in the storage 120 in response to a read request of the host.

The storage 120 may write data or output the written data under the control of the controller 110. The storage 120 may include a volatile or nonvolatile memory apparatus. In an embodiment, the storage 120 may be implemented using any of various nonvolatile memory devices, such as an electrically erasable and programmable ROM (EEPROM), a NAND flash memory, a NOR flash memory, a phase-change RAM (PRAM), a resistive RAM (ReRAM), a ferroelectric RAM (FRAM), and/or a spin torque transfer magnetic RAM (STT-MRAM). The storage 120 may include a plurality of dies, a plurality of chips, or a plurality of packages. In addition, the storage 120 may include a memory cell array, each cell of which may be a single-level cell that stores one-bit data or a multi-level cell that stores multi-bit data.

In an embodiment, the storage 120 may include a plurality of nonvolatile memory (NVM) apparatuses, e.g., NVM apparatuses 121 to 124.

The controller 110 in accordance with an embodiment may include a map data management component 20. The map data management component 20 may manage mapping information between physical addresses of physical storage spaces constituting the storage 120 and logical addresses assigned to the storage 120 by the host.

In an embodiment, the map data management component 20 may configure map segments by grouping a plurality of map data, which is mapping information between logical addresses and physical addresses, in units. A set of the map segments may be managed as a map table. The position of each map segment in the map table may be managed by an index table.

The index table and the map table may be stored in the storage 120. The index table and the map table may be loaded to and referenced by a working memory of the controller 110 when the data storage apparatus 10 is booted up. In an embodiment, the entire index table may be loaded to the working memory and some of map segments selected according to a predetermined condition may be loaded to the working memory.

When the size of the map segment is small, the size of the index table may increase. Due to the limitation of the working memory of the controller 110, the size of the index table may also be limited. As the capacity of the storage 120 increases, the size of the map segment also gradually increases. The loading time of the map segment is proportional to the size of the map segment, and when map data is updated, cost for updating a map segment including the changed map data increases.

The map data management component 20 may configure sub-segments by dividing the map segment, and load the map segment to the working memory in units of the sub-segments for update. Furthermore, since the map data management component 20 may manage the number of times a particular segment or sub-segment is referenced, validity and the like with respect to each sub-segment of each map segment, independent processing is possible for each sub-segment, so that it is possible to ensure map data management flexibility. Particularly, when the validity of the sub-segment is managed by a bitmap, it is possible to minimize data required for map data management.

FIG. 2 is a configuration diagram of the controller in accordance with an embodiment.

Referring to FIG. 2, the controller 110 may include a processor 111, a host interface (IF) 113, a ROM 1151, a RAM 1153, a memory interface (IF) 117, and the map data management component 20.

The processor 111 may be configured to transfer various types of control information for a data read or write operation for the storage 120 to the host IF 113, the RAM 1153, the memory IF 117, and the map data management component 20. In an embodiment, the processor 111 may operate according to firmware provided for various operations of the data storage apparatus 10. In an embodiment, the processor 111 may be configured in the form of a combination of hardware and software executed by the hardware so as to perform a function of a flash translation layer (FTL) including various functions for managing the storage 120.

The FTL may provide functions such as garbage collection, address mapping, and wear leveling, as well as a function for managing the attribute of each of a plurality of memory blocks constituting the storage 120, an error check and correction (ECC) function for detecting and correcting an error of data read from the storage 120, and the like.

The host IF 113 may provide a communication channel for receiving a command and a clock signal from the host and controlling data input/output under the control of the processor 111. The host IF 113 may provide a physical connection between the host and the data storage apparatus 10. The host IF 113 may provide interfacing with the data storage apparatus 10 in correspondence to a bus format of the host. The bus format of the host may include at least one of standard interface protocols such as a secure digital, a universal serial bus (USB), a multi-media card (MMC), an embedded MMC (eMMC), a personal computer memory card international association (PCMCIA), a parallel advanced technology attachment (DATA), a serial advanced technology attachment (SATA), a small computer system interface (SCSI), a serial attached SCSI (SAS), a peripheral component interconnection (PCI), a PCI express (PCI-E), and/or a universal flash storage (UFS).

The ROM 1151 may store program codes for the operation of the controller 110, for example, firmware or software, and store code data and the like used by the program codes.

The RAM 1153 may store data for the operation of the controller 110 or data generated by the controller 110.

The processor 111 may load a boot code stored in the storage 120 or the ROM 1151 to the RAM 1153 at the time of a boot operation, thereby controlling the boot operation of the data storage apparatus 10.

The memory IF 117 may provide a communication channel for signal transmission/reception between the controller 110 and the storage 120.

The map data management component 20 may manage map data including the mapping information between the physical addresses of the storage spaces constituting the storage 120 and the logical addresses assigned to the data storage apparatus 10 by the host. The map data is stored in the storage 120, and may be read and used by the controller 110 from the storage 120 if necessary.

The map data management component 20 may load map data satisfying a determined condition among the map data, for example, map data included in a request of the host, map data referenced more than the set number of times, or map data for performing a background operation of the data storage apparatus 10, from the storage 120 to the RAM 1153.

The map data management component 20 may configure at least one map segment SEG by grouping map data MD in a unit, and the controller 110 may assign a plurality of map cache lines having a size corresponding to the size of the map segment SEG to the RAM 1153. The unit may be of a fixed or predetermined size.

If the map data is updated when an operation according to a request of the host or the background operation is performed, the map data management component 20 may reflect the updated map data in the storage 120.

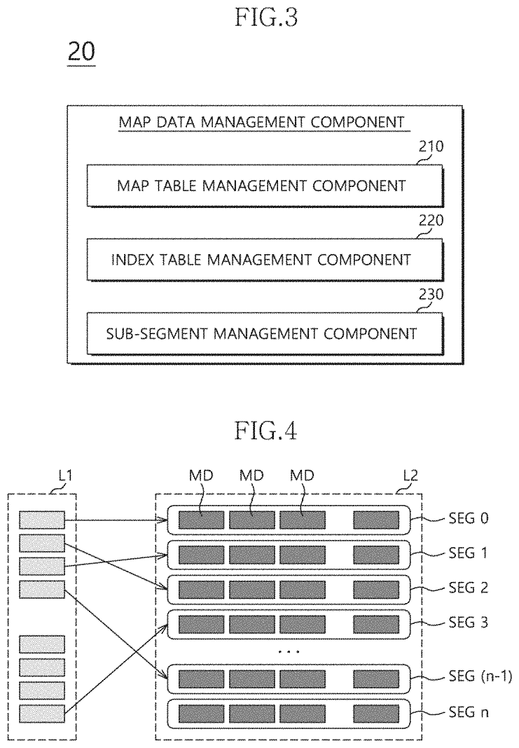

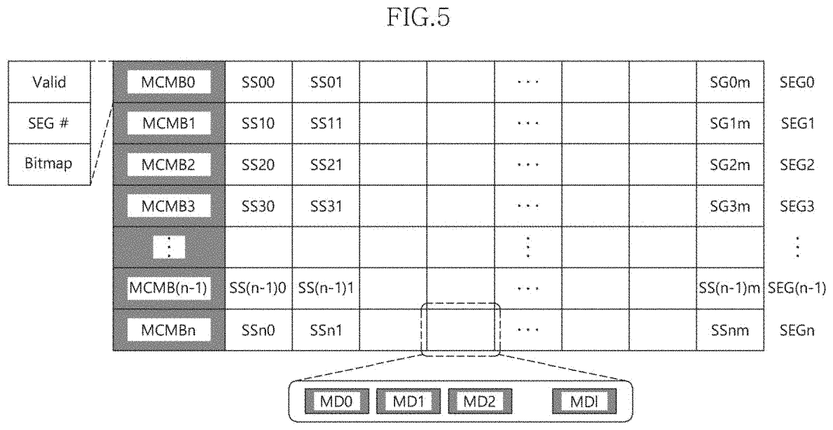

FIG. 3 is a diagram of the map data management component in accordance with an embodiment, and FIG. 4 is a diagram for explaining a map data management technique in accordance with an embodiment.

Referring to FIG. 3, the map data management component 20 may include a map table management component 210, an index table management component 220, and a sub-segment management component 230.

As illustrated in FIG. 4, the map table management component 210 may configure one or more map segments SEG0 to SEGn by grouping the map data MD, which is the mapping information between the logical addresses of the host and the physical addresses of the storage 120, in a unit. A set of the map segments SEG0 to SEGn may be managed as a map table L2. In an embodiment, the map segments SEG0 to SEGn may be configured by sequentially grouping consecutive logical addresses.

The index table management component 220 may configure the storage position of each of the map segments SEG0 to SEGn constituting the map table L2 as an index table L1 to manage the storage position of a valid map segment when the storage 120 does not support in-place update.

The sub-segment management component 230 may configure sub-segments by dividing each of the map segments SEG0 to SEGn according to a set criterion. Accordingly, each of the map segments SEG0 to SEGn may be composed of a plurality of sub-segments.

The map table management component 210 may manage a group of map data corresponding to a determined number of logical addresses as a map segment. The sub-segment management component 230 may configure sub-segments by dividing map data, which is included in each map segment, in a division unit. In an embodiment, a minimum unit, in which the controller 110 may read data from the storage 120, may be a page, and a division unit for configuring sub-segments may be a multiple of a minimum read unit (page, P); however, the present invention is not limited thereto.

When each of the map segments SEG0 to SEGn includes map data MD corresponding to L consecutive logical addresses, and sub-segments are configured by dividing the map segments SEG0 to SEGn by M times the minimum read unit P e.g. 4 KB size, each sub-segment may include map data MD corresponding to L/(P*M) logical addresses. A single logical address may represent a storage area storing a piece of the map data MD. Wherein L is a natural number greater than or equal to p, and M is a natural number.

As the sub-segments are configured, the sub-segment management component 230 may generate and manage meta data for each map segment.

In an embodiment, the controller 110 may assign, within the RAM 1153, a cache line having a size of the map segment SEG. Map data may be cached in the assigned cache line in units of the sub-segments selected according to a determined condition.

When the data storage apparatus 10 is booted up, the index table L1 and at least a part of the map table L2 may be loaded to and referenced by the RAM 1153 of the controller 110 in units of the sub-segments. When the map data is changed during the operation of the data storage apparatus 10, the map data may be updated in units of sub-segments.

FIG. 5 is a diagram for explaining a map data management method in accordance with an embodiment. FIG. 5 exemplifies the map table L2.

Referring to FIG. 5, it can be seen that the map segments SEG0 to SEGn are divided into sub-segments SS00 to SS0m, SS10 to SS1m, SS20 to SS2m, SS30 to SS3m, . . . , SSn0 to SSnm, respectively, and meta data MCMB0 to MCMBn is assigned to the map segments SEG0 to SEGn, respectively.

Each of the meta data MCMB0 to MCMBn may include a map segment validity field, denoted Valid in FIG. 5, a map segment identification field, denoted SEG# in FIG. 5, and a sub-segment validity field, denoted Bitmap in FIG. 5.

The map segment validity field may indicate whether a corresponding map segment is valid. The map segment identification field may indicate identification information assigned to the corresponding map segment. The sub-segment validity field may indicate whether each sub-segment included in the corresponding map segment is valid.

The sub-segment may include a plurality of pieces of map data MD0 to MDI, and whether each sub-segment is valid may be indicated as a bitmap in the sub-segment validity field. For example, when one map segment SEG is divided into (m+1) sub-segments, the sub-segment validity field may include information of (m+1) bits. When a specific sub-segment is in a valid state, the sub-segment validity field may indicate that by “1”, for example, and when the specific sub-segment is invalidated, the sub-segment validity field may indicate that by “0”, for example; however, the present invention is not limited thereto, as the reverse convention may be used.

According to an embodiment of the present invention, the sub-segment management component 230 may divide the map segment into the sub-segments, and independently manage the validity of each sub-segment for each map segment SEG. Accordingly, the map data may be loaded and updated in the working memory in units of the sub-segments to ensure map data management flexibility. Particularly, when the validity of the sub-segment is managed by the bitmap, it is possible to minimize data required for map data management.

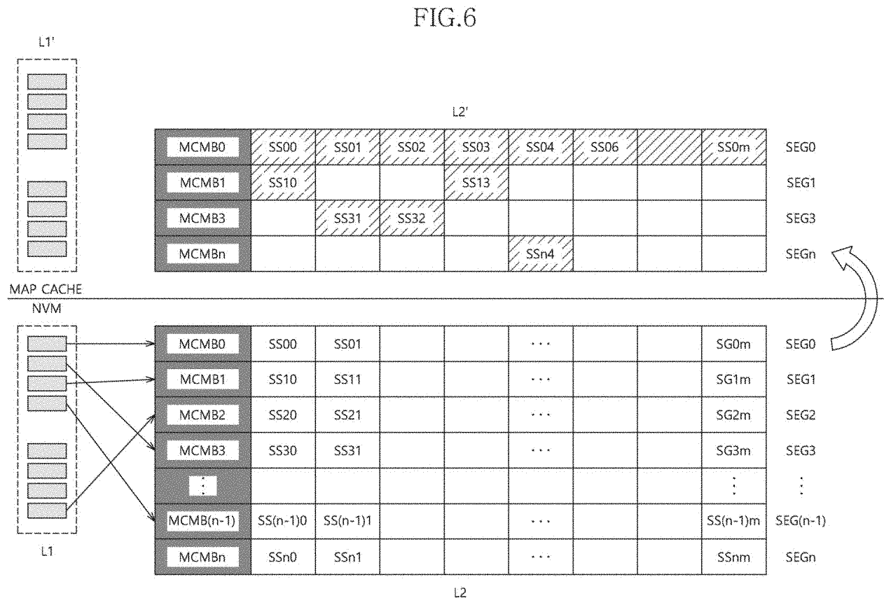

FIG. 6 is a diagram for explaining an operating method of the data storage apparatus in accordance with an embodiment.

As the data storage apparatus 10 operates, at least partial pieces of the map data of the map table L2 stored in the storage 120 may be loaded to the RAM 1153 of the controller 110, the RAM 1153 working as a map cache.

In an embodiment, all or some entries of the index table L1 may be loaded as an index table cache L1′. The map table L2 is composed of a plurality of sub-segments and at least one sub-segment selected according to a determined condition may be loaded to a map table cache L2′. At least one cache line having the size of the map segment SEG may be assigned to the map table cache L2′.

In an embodiment, a sub-segment of a map segment including map data included in a request of the host, map data referenced more than the set number of times, or map data required for performing the background operation of the data storage apparatus 10 itself may be loaded to the cache line assigned within the map table cache L2′.

As the map data is loaded to the RAM 1153, an access speed for the map data is improved, so that the data storage apparatus 10 may operate at a high speed.

As the capacity of the storage 120 increases, the size of the map segment also increases. According to an embodiment of the present invention, sub-segments are configured by dividing a map segment and map data is loaded and updated in the working memory in units of the sub-segments, so that it is possible to minimize cost for loading and updating the map data.

Referring to FIG. 6, all the map data of the map segments SEGO, SEG1, SEG3, and SEGn need not to be loaded to the map table cache L2′, even when partial pieces of the map data within the map segments SEG0, SEG1, SEG3, and SEGn need to be loaded to the map table cache L2′. Instead, only the sub-segments SS00 to SS0m, SS10, SS13, SS31, SS32, and SSn4 satisfying a determined condition among the sub-segments of the map segments SEG0, SEG1, SEG3, and SEGn may be loaded to the map table cache L2′.

Furthermore, validity of each sub-segment may be managed by the bitmap by relating the meta data MCMB0 to MCMBn respectively to the map segments SEG0 to SEGn. Accordingly, when a data read/write operation is repeated and mapping information is changed or unmapped, it is possible to invalidate map data in units of the sub-segments, not in units of the map segments, by changing bitmap information.

As a consequence, as a processing unit for handling the map data is optimized, it is possible to efficiently load and update the map data.

Recently, technology of uploading the map data to a memory provided in the host for use has been studied in order to improve a response speed of the data storage apparatus 10.

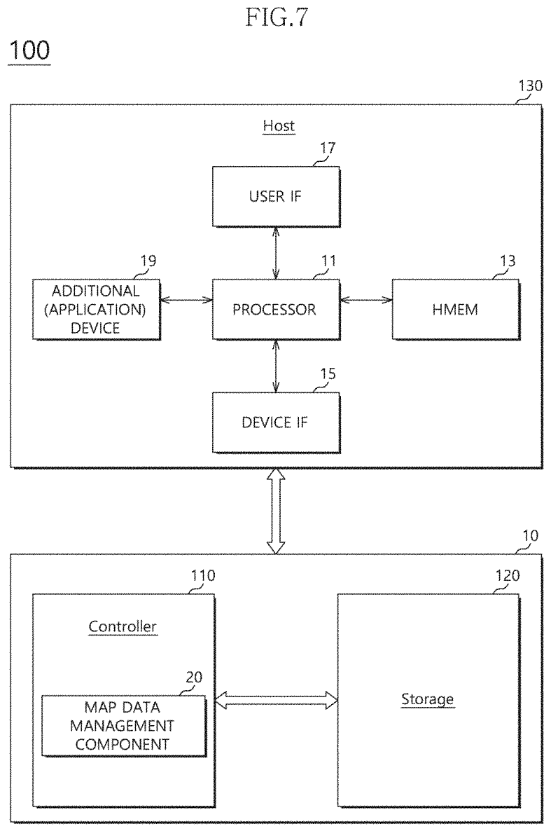

FIG. 7 is a configuration diagram of a computing apparatus in accordance with an embodiment.

Referring to FIG. 7, a computing apparatus 100 may include a host 130 and a data storage apparatus 10.

The host 130 may include a processor 11, a host memory (HMEM) 13, a device interface (IF) 15, a user interface (IF) 17, and an additional (application) device 19.

The processor 11 may control overall operations of the computing apparatus 100 and perform logic operations. The processor 11 may be a hardware-based data processing device including a circuit physically configured to execute commands included in codes or programs.

The HMEM 13 may include a main memory of the host 130 or the computing apparatus 100 communicating with the processor 11. Codes and data to be executed and referenced by the processor 11 may be temporarily stored in the HMEM 13. The processor 11 may execute codes of an operating system, an application and the like by using the HMEM 13 and process data. The HMEM 13 may be any of various random access memories including a volatile memory such as a static RAM (SRAM), a dynamic RAM (DRAM), and a synchronous DRAM (SDRAM), or a nonvolatile memory such as a phase-change RAM (PRAM), a magnetic RAM (MRAM), a resistive RAM (RRAM), and/or a ferroelectric RAM (FeRAM).

The device IF 15 may provide a physical connection between the host 130 and the data storage apparatus 10.

The user IF 17 may communicate with a user under the control of the processor 11. For example, the user IF 17 may include user input interfaces such as a keyboard, a keypad, a button, a touch panel, a touch screen, a touch pad, a touch ball, a camera, a microphone, a gyroscope sensor, and a vibration sensor. The user IF 17 may include user output interfaces such as a liquid crystal display (LCD), an organic light emitting diode (OLED) display device, an active matrix OLED (AMOLED) display device, an LED, a speaker, and a monitor.

The additional (application) device 19 may include a communication module that enables the computing apparatus 100 to communicate with an external device by various wired or wireless communication protocols, an image capturing device and the like.

The data storage apparatus 10 may include a controller 110 and a storage 120, and may be configured as the data storage apparatus 10 illustrated in FIG. 1 to FIG. 3. Accordingly, the data storage apparatus 10 may configure map segments by grouping map data, which is mapping information between logical addresses and physical addresses, in a set unit, and configure sub-segments by dividing each map segment.

The host 130 may store data, which needs to be stored in the long term, in the data storage apparatus 10. The data storage apparatus 10 may store source codes of various types of software such as a boot image, an operating system, and an application for driving the computing apparatus 100, and data processed by the source codes.

The controller 110 of the data storage apparatus 10 may manage various pieces of meta data for managing the storage 120. The meta data is stored in the storage 120, and the controller 110 may control the meta data to reside in a device memory 115 from the storage 120 for use, if necessary.

In an embodiment, the meta data may include map data MD. The controller 110 may load a sub-segment of a map segment, which includes the entire map data MD or map data satisfying a determined condition among the entire map data MD, for example, map data included in a request of the host, map data referenced more than the set number of times, or map data required for performing the background operation of the data storage apparatus 10 itself, to the HMEM 13 as host map cache data. Accordingly, the host 130 may transmit a command including a physical address to the data storage apparatus 10 by referring to the host map cache data loaded to the HMEM 13. As the command of the host 130 is requested together with the physical address, the controller 110 of the data storage apparatus 10 may perform address translation or omit an operation of reading the map data MD from the storage 120. Accordingly, time it takes for the data storage apparatus 10 to process the request of the host 130 is reduced, so that the operating speed of the computing apparatus 100 may be improved.

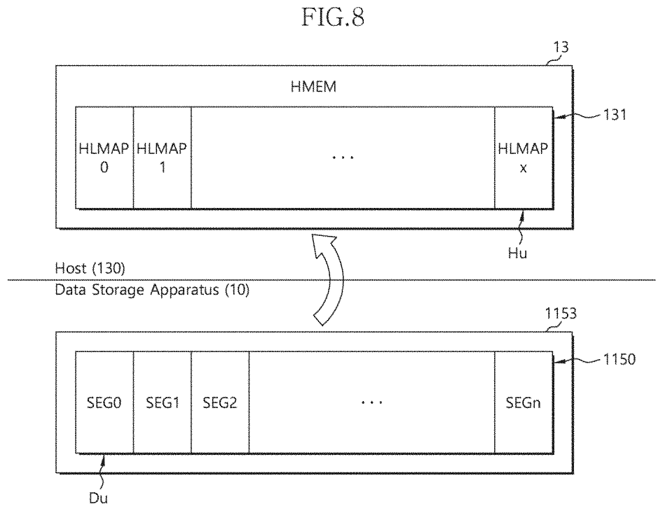

FIG. 8 is a diagram for explaining an operating method of the computing apparatus in accordance with an embodiment.

As illustrated in FIG. 8, the processor 11 of the host 130 may assign a host map cache data storage space 131 into the HMEM 13. The host map cache data storage space 131 may be composed of a plurality of host unit areas HU.

In order to store new host map cache data HLMAP, the processor 11 may assign the host unit area HU. When there is no remaining area where the host unit area HU is to be assigned, the processor 11 may select a host unit area HU satisfying a set criterion among the plurality of host unit areas HU. Then, the processor 11 may update host map cache data HLMAP in the selected host unit area HU to new host map cache data HLMAP.

The controller 110 of the data storage apparatus 10 may assign a map cache area 1150 to the RAM 1153. The map cache area 1150 may be divided into device unit areas DU which are a plurality of cache lines having a size corresponding to the size of the map segment SEG. The entire map data MD stored in the storage 120 or the sub-segments selected by a set criterion may be cached in the device unit areas DU assigned to the RAM 1153.

As the map segment SEG is divided into a plurality of sub-segments, all or some of the sub-segments constituting the map segment SEG may be stored in the device unit area DU assigned to each map segment SEG.

The size of the device unit area DU assigned to the RAM 1153 may be different from the size of the host unit area HU assigned to the HMEM 13. Accordingly, in consideration of the size of the host unit area HU, at least one sub-segment cached in the device unit area DU may be selected and cached in the host unit area HU.

That is, in order to maximally utilize the host unit area HU assigned to the HMEM 13, the sub-segment may be selected to have a size corresponding to the size of the host unit area HU and cached in the HMEM 13 of the host 130.

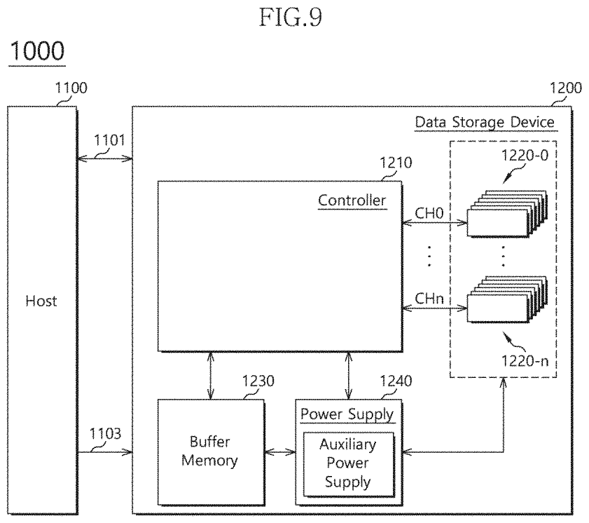

FIG. 9 is a diagram illustrating a data storage system 1000, in accordance with an embodiment.

Referring to FIG. 9, the data storage 1000 may include a host device 1100 and the data storage device 1200. In an embodiment, the data storage device 1200 may be configured as a solid state drive (SSD).

The data storage device 1200 may include a controller 1210, a plurality of nonvolatile memory devices 1220-0 to 1220-n, a buffer memory device 1230, a power supply 1240, a signal connector 1101, and a power connector 1103.

The controller 1210 may control general operations of the data storage device 1200. The controller 1210 may include a host interface, a control component, a random access memory used as a working memory, an error correction code (ECC) component, and a memory interface. In an embodiment, the controller 1210 may configured as controller 110 shown in FIGS. 1 and 2.

The host device 1100 may exchange a signal with the data storage device 1200 through the signal connector 1101. The signal may include a command, an address, data, and the like.

The controller 1210 may analyze and process the signal received from the host device 1100. The controller 1210 may control operations of internal function blocks according to firmware or software for driving the data storage device 1200.

The buffer memory device 1230 may temporarily store data to be stored in at least one of the nonvolatile memory devices 1220-0 to 1220-n. Further, the buffer memory device 1230 may temporarily store the data read from at least one of the nonvolatile memory devices 1220-0 to 1220-n. The data temporarily stored in the buffer memory device 1230 may be transmitted to the host device 1100 or at least one of the nonvolatile memory devices 1220-0 to 1220-n according to control of the controller 1210.

The nonvolatile memory devices 1220-0 to 1220-n may be used as storage media of the data storage device 1200. The nonvolatile memory devices 1220-0 to 1220-n may be coupled with the controller 1210 through a plurality of channels CH0 to CHn, respectively. One or more nonvolatile memory devices may be coupled to one channel. The nonvolatile memory devices coupled to each channel may be coupled to the same signal bus and data bus.

The power supply 1240 may provide power inputted through the power connector 1103 to the controller 1210, the nonvolatile memory devices 1220-0 to 1220-n and the buffer memory device 1230 of the data storage device 1200. The power supply 1240 may include an auxiliary power supply. The auxiliary power supply may supply power to allow the data storage device 1200 to be properly terminated when a sudden power interruption occurs. The auxiliary power supply may include bulk-capacity capacitors sufficient to store the needed charge.

The signal connector 1101 may be configured as any of various types of connectors depending on an interface scheme between the host device 1100 and the data storage device 1200.

The power connector 1103 may be configured as any of various types of connectors depending on a power supply scheme of the host device 1100.

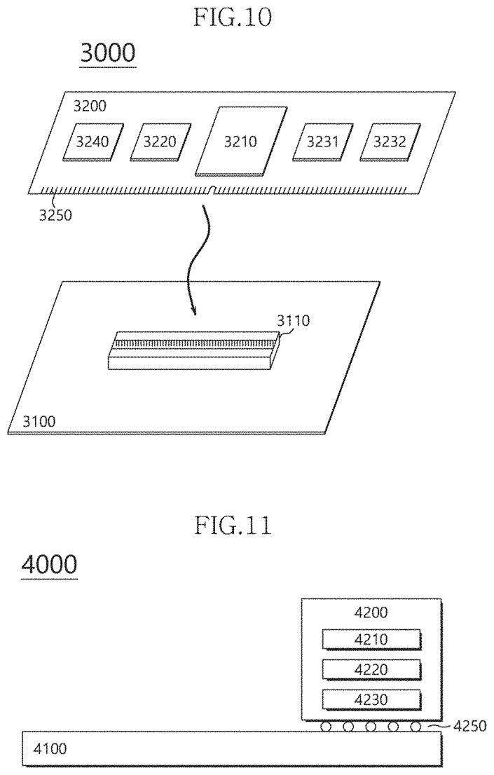

FIG. 10 is a diagram illustrating a data processing system 3000, in accordance with an embodiment. Referring to FIG. 10, the data processing system 3000 may include a host device 3100 and a memory system 3200.

The host device 3100 may be configured in the form of a board, such as a printed circuit board. Although not shown, the host device 3100 may include internal function blocks for performing the function of a host device.

The host device 3100 may include a connection terminal 3110, such as a socket, a slot, or a connector. The memory system 3200 may be mated to the connection terminal 3110.

The memory system 3200 may be configured in the form of a board, such as a printed circuit board. The memory system 3200 may be referred to as a memory module or a memory card. The memory system 3200 may include a controller 3210, a buffer memory device 3220, nonvolatile memory devices 3231 and 3232, a power management integrated circuit (PMIC) 3240, and a connection terminal 3250.

The controller 3210 may control general operations of the memory system 3200. The controller 3210 may be configured in the same manner as the controller 110 shown in FIGS. 1 to 3.

The buffer memory device 3220 may temporarily store data to be stored in the nonvolatile memory devices 3231 and 3232. Further, the buffer memory device 3220 may temporarily store data read from the nonvolatile memory devices 3231 and 3232. The data temporarily stored in the buffer memory device 3220 may be transmitted to the host device 3100 or the nonvolatile memory devices 3231 and 3232 according to control of the controller 3210.

The nonvolatile memory devices 3231 and 3232 may be used as storage media of the memory system 3200.

The PMIC 3240 may provide the power inputted through the connection terminal 3250 to the inside of the memory system 3200. The PMIC 3240 may manage the power of the memory system 3200 according to control of the controller 3210.

The connection terminal 3250 may be coupled to the connection terminal 3110 of the host device 3100. Through the connection terminal 3250, signals such as commands, addresses, data, and so forth, and power may be transferred between the host device 3100 and the memory system 3200. The connection terminal 3250 may be configured as any of various types depending on an interface scheme between the host device 3100 and the memory system 3200. The connection terminal 3250 may be disposed on or in a side of the memory system 3200, as shown.

FIG. 11 is a diagram illustrating a data processing system 4000 in accordance with an embodiment. Referring to FIG. 11, the data processing system 4000 may include a host device 4100 and a memory system 4200.

The host device 4100 may be configured in the form of a board, such as a printed circuit board. Although not shown, the host device 4100 may include internal function blocks for performing the function of a host device.

The memory system 4200 may be configured in the form of a surface-mounted type package. The memory system 4200 may be mounted to the host device 4100 through solder balls 4250. The memory system 4200 may include a controller 4210, a buffer memory device 4220, and a nonvolatile memory device 4230.

The controller 4210 may control general operations of the memory system 4200. The controller 4210 may be configured in the same manner as the controller 110 shown in FIGS. 1 to 3.

The buffer memory device 4220 may temporarily store data to be stored in the nonvolatile memory device 4230. Further, the buffer memory device 4220 may temporarily store data read from the nonvolatile memory device 4230. The data temporarily stored in the buffer memory device 4220 may be transmitted to the host device 4100 or the nonvolatile memory device 4230 according to control of the controller 4210.

The nonvolatile memory device 4230 may be used as the storage medium of the memory system 4200.

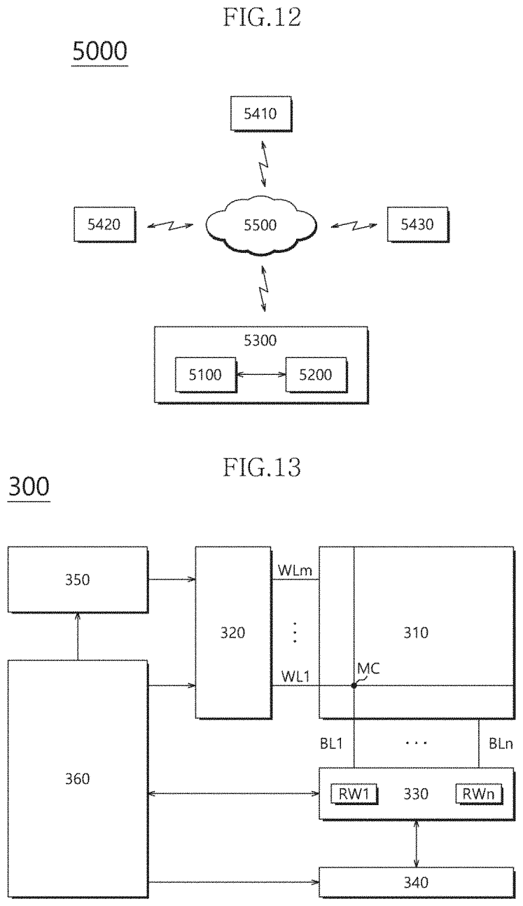

FIG. 12 is a diagram illustrating a network system 5000 including a data storage device, in accordance with an embodiment.

Referring to FIG. 12, the network system 5000 may include a server system 5300 and a plurality of client systems 5410, 5420, and 5430, which are coupled through a network 5500.

The server system 5300 may service data in response to requests from the plurality of client systems 5410 to 5430. For example, the server system 5300 may store the data provided by the plurality of client systems 5410 to 5430. For another example, the server system 5300 may provide data to the plurality of client systems 5410 to 5430.

The server system 5300 may include a host device 5100 and a memory system 5200. The memory system 5200 may be configured as the memory system 10 shown in FIG. 1, the data storage device 1200 shown in FIG. 9, the memory system 3200 shown in FIG. 10, or the memory system 4200 shown in FIG. 11.

FIG. 13 is a block diagram illustrating a nonvolatile memory device 300 included in a data storage device, such as the data storage device 10, in accordance with an embodiment. Referring to FIG. 13, the nonvolatile memory device 300 may include a memory cell array 310, a row decoder 320, a data read/write block 330, a column decoder 340, a voltage generator 350, and control logic 360.

The memory cell array 310 may include memory cells MC which are arranged at areas where word lines WL1 to WLm and bit lines BL1 to BLn intersect with each other.

The memory cell array 310 may comprise a three-dimensional memory array, which has a stacked structure extending in a perpendicular direction to the flat surface of a semiconductor substrate. Moreover, the three-dimensional memory array also covers a structure including NAND strings, the memory cells of which are stacked perpendicular to the flat surface of a semiconductor substrate.

The structure of the three-dimensional memory array is not limited to the examples indicated above. The memory array structure can be formed in a highly integrated manner with horizontal directionality as well as vertical directionality. In an embodiment, in the NAND strings of the three-dimensional memory array, memory cells are arranged in the parallel and perpendicular directions with respect to the surface of the semiconductor substrate. The memory cells may be variously spaced to provide different degrees of integration.

The row decoder 320 may be coupled with the memory cell array 310 through the word lines WL1 to WLm. The row decoder 320 may operate according to control of the control logic 360. The row decoder 320 may decode an address provided by an external device (not shown). The row decoder 320 may select and drive the word lines WL1 to WLm, based on a decoding result. For instance, the row decoder 320 may provide a word line voltage, provided by the voltage generator 350, to the word lines WL1 to WLm.

The data read/write block 330 may be coupled with the memory cell array 310 through the bit lines BL1 to BLn. The data read/write block 330 may include read/write circuits RW1 to RWn, respectively, corresponding to the bit lines BL1 to BLn. The data read/write block 330 may operate according to control of the control logic 360. The data read/write block 330 may operate as a write driver or a sense amplifier, according to an operation mode. For example, the data read/write block 330 may operate as a write driver, which stores data provided by the external device in the memory cell array 310 in a write operation. For another example, the data read/write block 330 may operate as a sense amplifier, which reads out data from the memory cell array 310 in a read operation.

The column decoder 340 may operate according to control of the control logic 360. The column decoder 340 may decode an address provided by the external device. The column decoder 340 may couple the read/write circuits RW1 to RWn of the data read/write block 330, respectively corresponding to the bit lines BL1 to BLn, with data input/output lines or data input/output buffers, based on a decoding result.

The voltage generator 350 may generate voltages to be used in internal operations of the nonvolatile memory device 300. The voltages generated by the voltage generator 350 may be applied to the memory cells of the memory cell array 310. For example, a program voltage generated in a program operation may be applied to a word line of memory cells for which the program operation is to be performed. For another example, an erase voltage generated in an erase operation may be applied to a well area of memory cells for which the erase operation is to be performed. For still another example, a read voltage generated in a read operation may be applied to a word line of memory cells for which the read operation is to be performed.

The control logic 360 may control general operations of the nonvolatile memory device 300, based on control signals provided by the external device. For example, the control logic 360 may control operations of the nonvolatile memory device 300 such as read, write, and erase operations of the nonvolatile memory device 300.

While various embodiments have been illustrated and described, it will be understood by those skilled in the art that the embodiments described are examples only. Accordingly, the present invention is not limited by or to any of the disclosed embodiments. Rather, the present invention encompasses all modifications and variations of any of the disclosed embodiments that fall within the scope of the claims.

What is claimed is:

1. A data storage apparatus comprising:
a storage; and
a controller configured to control the storage in response to a request of a host,
wherein the controller comprises a map data management component configured to:
generate one or more map segments, each of which includes a plurality of pieces of map data, which represent mapping information between logical addresses of the host and physical addresses of the storage;
store the map segments in the storage;
group the map data in each of the map segments into groups of one or more sub-segments; and
load the map data of each of the map segments in units of the sub-segments.

2. The data storage apparatus according to claim 1, wherein the map data management component manages, as meta data for each of the map segments, map segment identification information, map segment validity information, and validity information of each of the one or more sub-segments in the map segment.

3. The data storage apparatus according to claim 2, wherein the validity information of the sub-segment is represented by bitmap data.

4. The data storage apparatus according to claim 1, wherein the map data management component is configured to group the map data in each of the map segments into groups of one or more sub-segments by dividing each of the map segments by a multiple of a unit of data read from the storage.

5. The data storage apparatus according to claim 1, further comprising: a working memory configured to temporarily store data for the storage and the controller to operate in response to the request of the host.

6. The data storage apparatus according to claim 5, wherein the working memory is located within or external to the controller.

7. The data storage apparatus according to claim 1,
wherein the host provides a working memory for temporarily storing data for the storage and the controller to operate, and
wherein the controller is configured to load the map segments to the working memory in units of the sub-segments.

8. A controller that controls a storage in response to a request of a host, the controller comprising:
a map table management component configured to:
generate one or more map segments, each of which includes a plurality of pieces of map data, which represent mapping information between logical addresses of the host and physical addresses of the storage; and
store the map segments in the storage; and
a sub-segment management component configured to:
group the map data in each of the map segments into groups of one or more sub-segments; and
load the map data of each of the one or more map segments in units of the sub-segments.

9. The controller according to claim 8, wherein the map table management component is configured to generate the map segments by sequentially grouping consecutive logical addresses.

10. The controller according to claim 8, further comprising: an index table management component configured to manage storage positions of the map segments.

11. The controller according to claim 8, wherein the sub-segment management component manages, as meta data for each of the map segments, map segment identification information, map segment validity information, and validity information of each of the one or more sub-segments in the map segment.

12. The controller according to claim 11, wherein the validity information of the sub-segment is represented by bitmap data.

13. The controller according to claim 8, wherein the sub-segment management component is configured to group the map data in each of the map segments into groups of one or more sub-segments by dividing each of the one or more map segments by a multiple of a unit of data read from the storage.

14. The controller according to claim 8, further comprising: a working memory configured to temporarily store data for the storage and the controller to operate in response to the request of the host.

15. The controller according to claim 8,
wherein the host provides a working memory for temporarily storing data for the storage and the controller to operate, and
wherein the controller is configured to load the map segments to the working memory in units of the sub-segments.

16. An operating method of a data storage apparatus including a storage and a controller that controls the storage in response to a request of a host, the operating method comprising:
generating, by the controller, one or more map segments, each of which includes a plurality of pieces of map data, which are mapping information between logical addresses of the host and physical addresses of the storage, and stores the map segments in the storage;
grouping, by the controller, the map data in each of the one or more map segments into groups of one or more sub-segments; and
loading the map data of each of the map segments in units of the one or more sub-segments.

17. The operating method according to claim 16, further comprising: generating, by the controller, as meta data for each of the map segments, map segment identification information, map segment validity information, and validity information of each of the one or more sub-segments included in the map segment.

18. The operating method according to claim 17, wherein the validity information of the sub-segment is represented by bitmap data.

19. The operating method according to claim 16, wherein the grouping of the map data in each of the one or more map segments into groups of one or more sub-segments includes dividing each of the map segments by a multiple of a unit of data read from the storage.

20. The operating method according to claim 16,
wherein the data storage apparatus further comprises: a working memory configured to temporarily store data for the storage and the controller to operate in response to the request of the host, and
wherein the working memory is an internal memory or an external memory of the controller.

21. The operating method according to claim 16,
wherein the host provides a working memory for temporarily storing data for the storage and the controller to operate, and
wherein the loading of the map data comprises loading the map segments to the working memory in units of the sub-segments.

22. A memory system comprising:
a memory device including plural storage areas and configured to store a map table having information of a map segment and corresponding meta data; and
a controller configured to:
cache therein the information of map segment by units of sub-segments;
control the memory device to perform an operation based on the cached information; and
update the map segment by units of sub-segments as a result of the operation,
wherein the map segment includes plural sub-segments, each including one or more pieces of map data respectively corresponding to the storage areas, and
wherein the meta data includes validity information of the map segment and the respective sub-segments.
